(19) United States
(12) Patent Application Publication
(10) Pub. No.: US 2009/0159367 A1
(43) Pub. Date: Jun. 25, 2009

(54) Side-Security-Ladder

(76) Inventor: Luis Joel Ortiz Perez, Patillas, PR (US)

Correspondence Address: Luis J. Ortiz Perez, P. O. Box 978, Patillas, PR, 00723, US

(21) Appl. No.: 12/002,957

(22) Filed: Dec. 19, 2007

(51) Int. Cl. E06C 7/44

(52) U.S. Cl. 182/111; 182/201

(57) ABSTRACT

The Side-Security-Ladder 26 is the first stabilizer with multiple uses for Extension Ladder 24 that focuses on the security area. The stabilizer will allow people to climb up and down the Extension Ladder 24 in a safe, stable and confident way and not need another person to hold the Extension Ladder 24. It has the versatility of turning 360°. It can move from 90° vertical to 90° horizontal. It can also extend from 2 to 3 feet and it has a shoe that pivots up to 30°. The Side-Security-Ladder 26 can be adjusted to aluminum and fiber glass Extension Ladder 24. All of these versatilities are done in a safe way. The Side-Security-Ladder 26 can be used on any place of the side (lateral) legs of the Extension Ladder 24, against the walls, floors, roofs and eaves. The Side-Security-Ladder 26 has two individual legs that can be adjusted to one's necessities.

### BACKGROUND OF THE INVENTION

The idea of inventing the Side-Security-Ladder 26 came to me after witnessing various accidents, with Extension Ladder 24. These ladders are unreliable, unstable and unsafe. For example, when an Extension Ladder 24 moves to either side, there is no support to fix the ladder in place. Another example with the Extension Ladder 24 is that those that measure 20 feet move too much when someone is climbing up or down, because it has nothing that will keep it stable. Examples of the different usages of the Side-Security-Ladder 26 are found in the Drawing.

The main focus is to make the first stabilizer with multiple uses for Extension Ladder 24 in the security area. I want to offer security, stability and confidence to all those people who use Extension Ladder 24 and avoid accidents.

### BRIEF SUMMARY OF THE INVENTION

The Side-Security-Ladder 26 allows people to climb an Extension Ladder 24 in a safe, stable and confident manner. The Side-Security-Ladder 26 offers the advantage that it has multiple uses. It can be used at the top, center or bottom part of the ladder. The Side-Security-Ladder 26 has a channel that is adhered to the side legs of the Extension Ladder 24. It has a screw on one of the fringes of the channel that has an aluminum plate. This allows securing the Side-Security-Ladder 26 to the Extension Ladder 24. The Side-Security-Ladder 26 has the versatility of turning 360°, it measures 2 feet and it extends in a telescoping way up to 3 feet. It opens from 90° vertical to 90° horizontal and it has a steel shoe at the bottom that pivots up to 30° for security. The best part is that the Side-Security-Ladder 26 is two individual legs that adjust to one's necessities and it does not need any tools to assemble it nor drill any holes in the Extension Ladder 24.

All of these functions make the Side-Security-Ladder 26 a safe, stable and confident product. It will avoid accidents, like when the Extension Ladder 24 moves to either side. It will also avoid the turbulent movements when one is climbing up or down the Extension Ladder 24. Since the Side-Security-Ladder 26 has two individual legs, it can offer other security uses that are illustrated in the Drawings.

My objective is clear: to offer security, stability and confidence to people using Extension Ladder 24 with my product, the Side-Security-Ladder 26. This way, people will continue having a healthy quality of life without injuries or accidents that may occur when using an Extension Ladder 24. It will also avoid the employers the excessive expenses with the insurance policies, reducing or eliminating accidents.

### BRIEF DESCRIPTION OF THE SEVERAL VIEWS OF THE DRAWING

FIG. 00: We see the Side-Security-Ladder 26 in an isometric view.

FIG. 1A: We see the front side of the Side-Security-Ladder 26 with its components numbered.

FIG. 2B: We see the back side of the Side-Security-Ladder 26 with its components of numbered.

FIG. 3C: We see the lateral view of the Side-Security-Ladder 26 with nits components numbered.

FIG. 4D: We see a top view of the Side-Security-Ladder 26 with its components numbered.

FIG. 5E: We see the Side-Security-Ladder 26 functioning on the higher part of an Extension Ladder 24 (previous art) against the wall 25.

FIG. 6F: We see the Side-Security-Ladder 26 functioning in the middle (center) part of an Extension Ladder 24 (previous art) against the wall 25.

FIG. 7G: We see the Side-Security-Ladder 26 functioning on the bottom part of an Extension Ladder 24 (previous art) against the floor 23.

FIG. 8H: We see the Side-Security-Ladder 26 functioning on an Extension Ladder 24 (previous art) against the wall 25. We can see that one of the legs of the Side-Security-Ladder 26 is higher than the other leg. It is used this way because of the interruption of a window 22.

FIG. 9I: We see the Side-Security-Ladder 26 functioning on the bottom part of an Extension Ladder 24 (previous art) against the wall 25.

FIG. 10J: We see the Side-Security-Ladder 26 functioning on the higher part of an Extension Ladder 24 (previous art) against the roof 27.

FIG. 11K: We see the Side-Security-Ladder 26 functioning on the higher part of an Extension Ladder 24 (previous art) behind high eaves 28 against the roof 27.

FIG. 12L: We see the Side-Security-Ladder 26 functioning on the bottom part of an Extension Ladder 24 (previous art) against a floor 23 that is plain and with an elevation.

FIG. 13M: We see the Side-Security-Ladder 26 functioning on the bottom part of an Extension Ladder 24 (previous art) against a ladder 25.

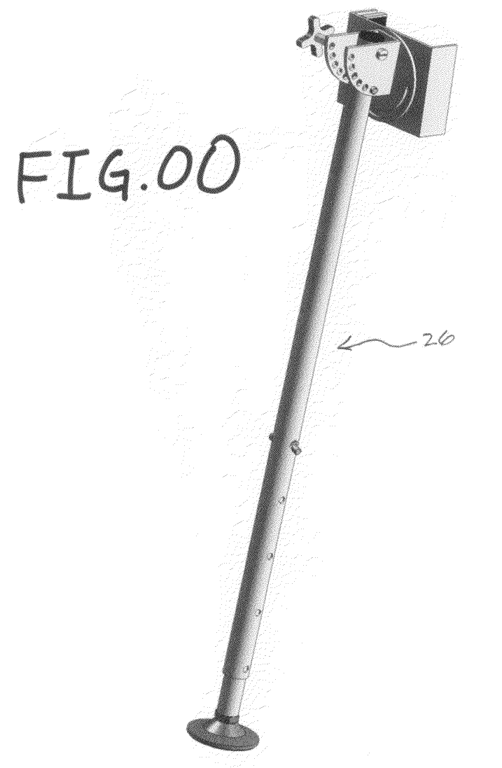

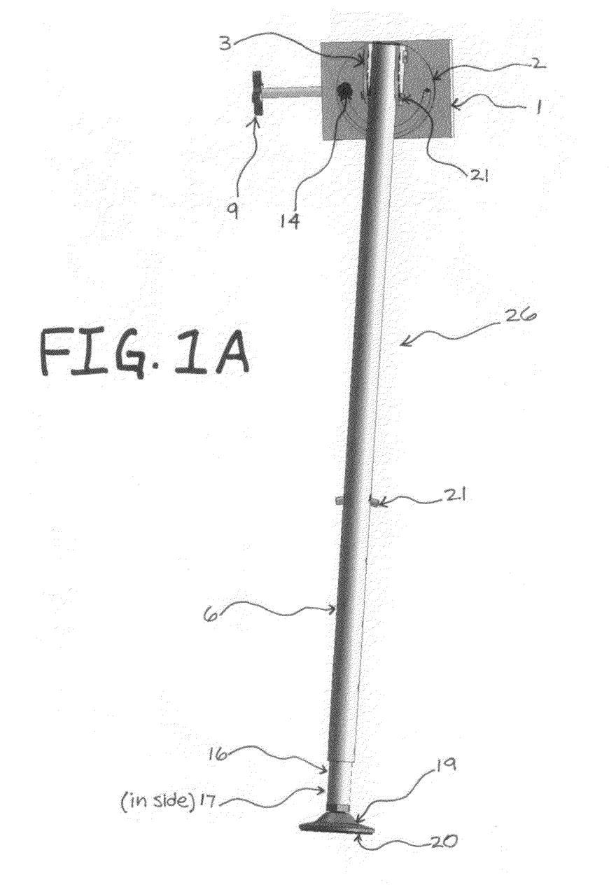

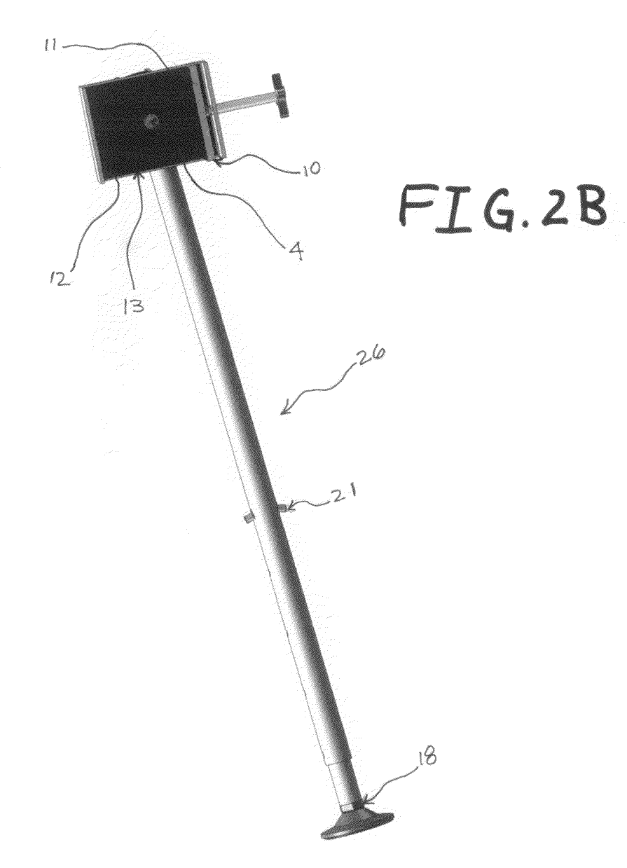

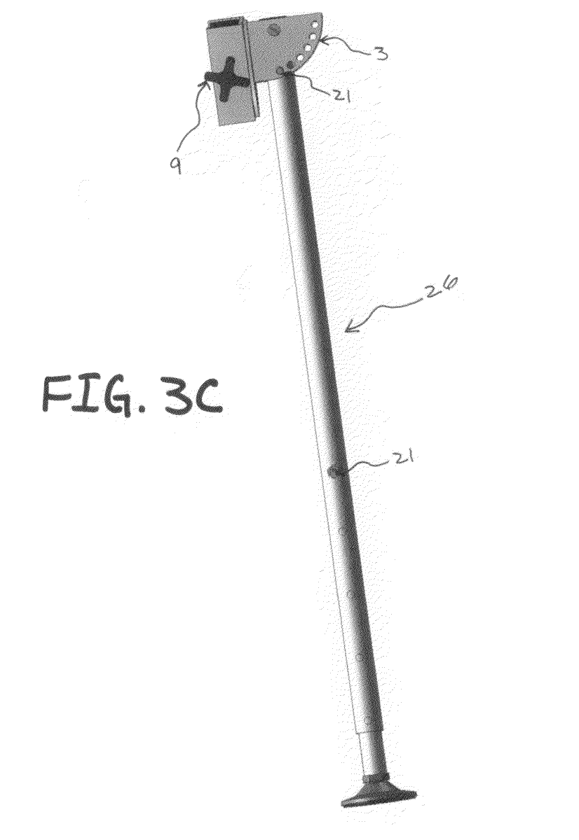

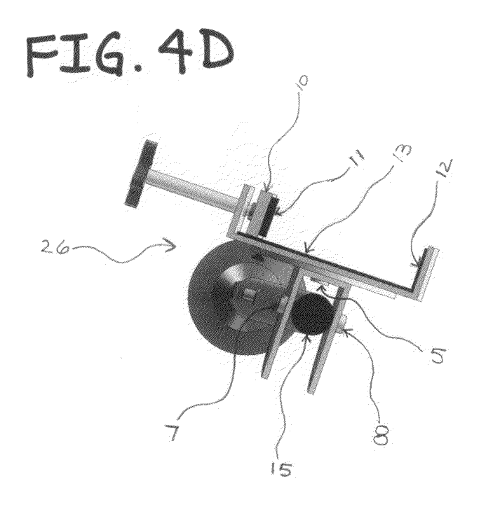

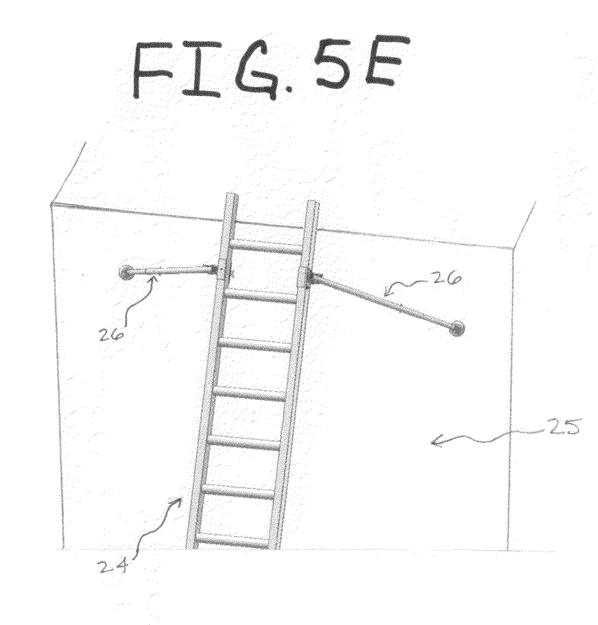

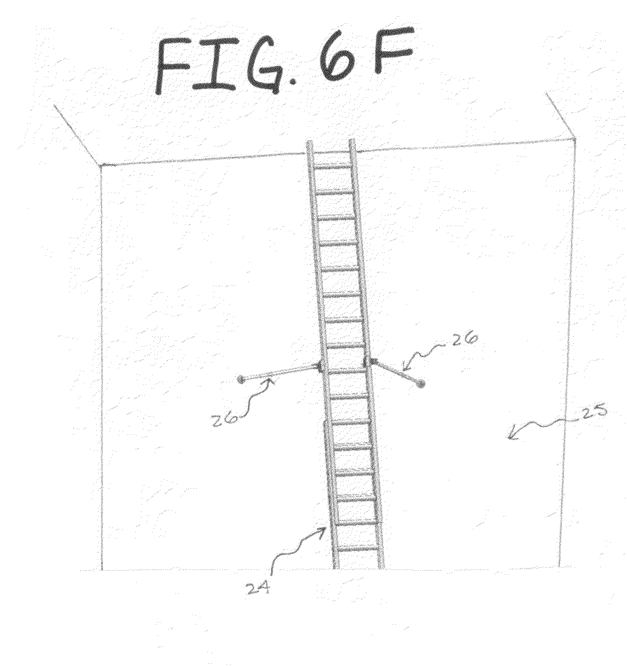

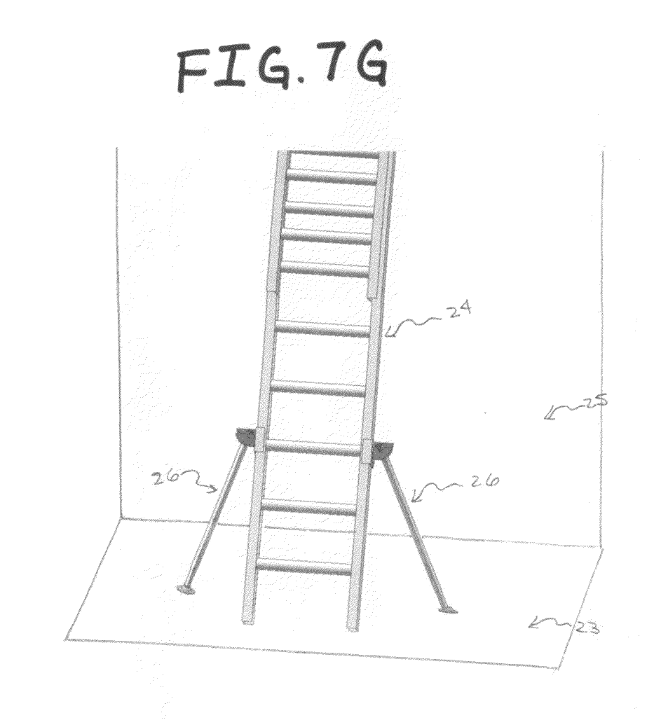

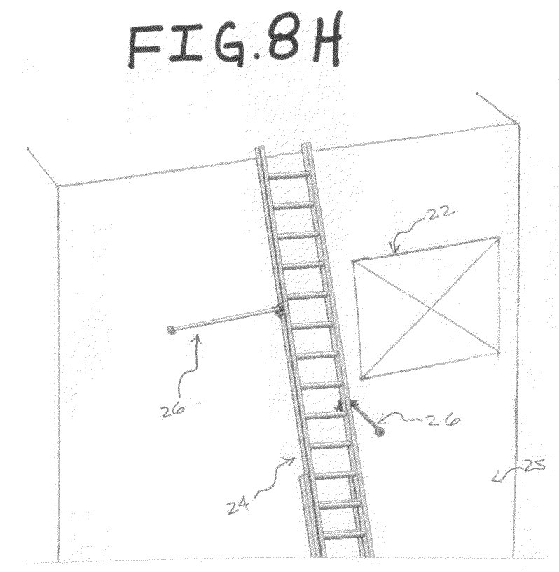

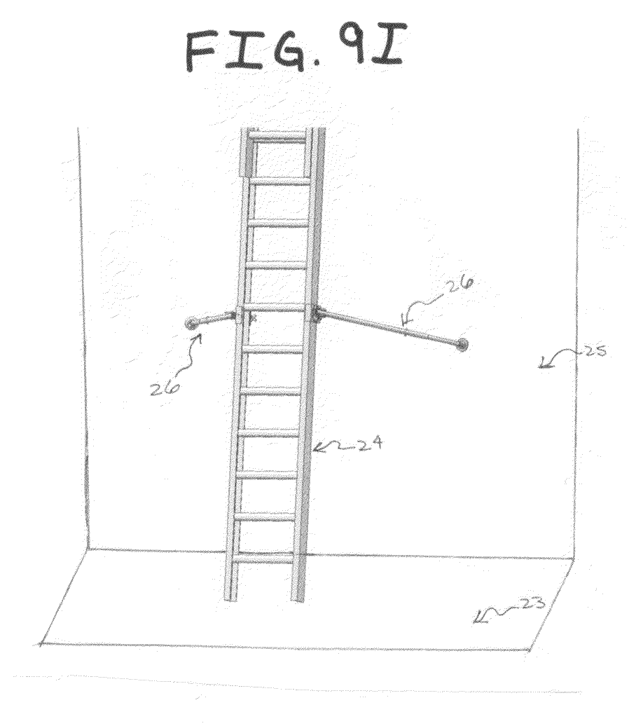

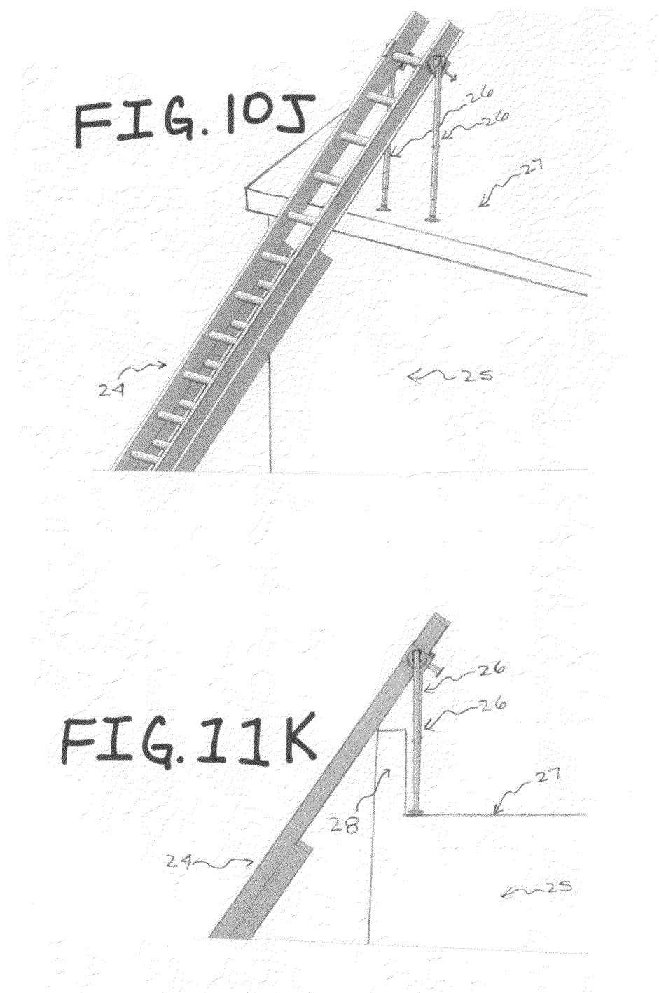

From FIG. 1 to FIG. 21 we see all the components that form the Side-Security-Ladder 26.

### DETAILED DESCRIPTION OF THE INVENTION

In this section we will see the used and function of each of the components that form the Side-Security-Ladder 26. We will also see the manufacturing process and the assembly. How to used the product and of that materials each of the components that form the Side-Security-Ladder all made of are also found in this section.

Channel-Ladder-Connection FIG. 1: It is a channel that uses the side (lateral) legs of the Extension Ladder 24 as a guide.

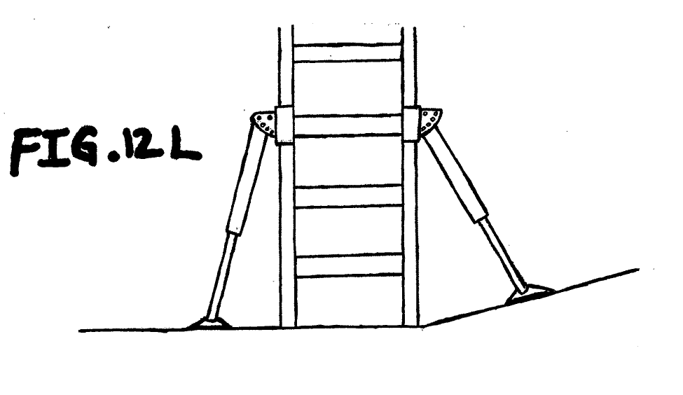

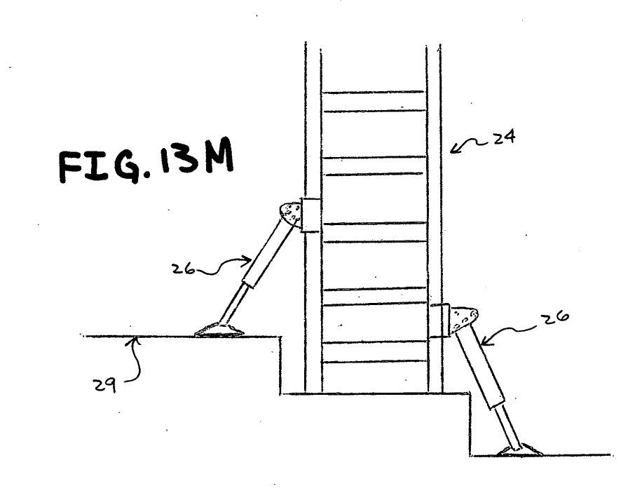

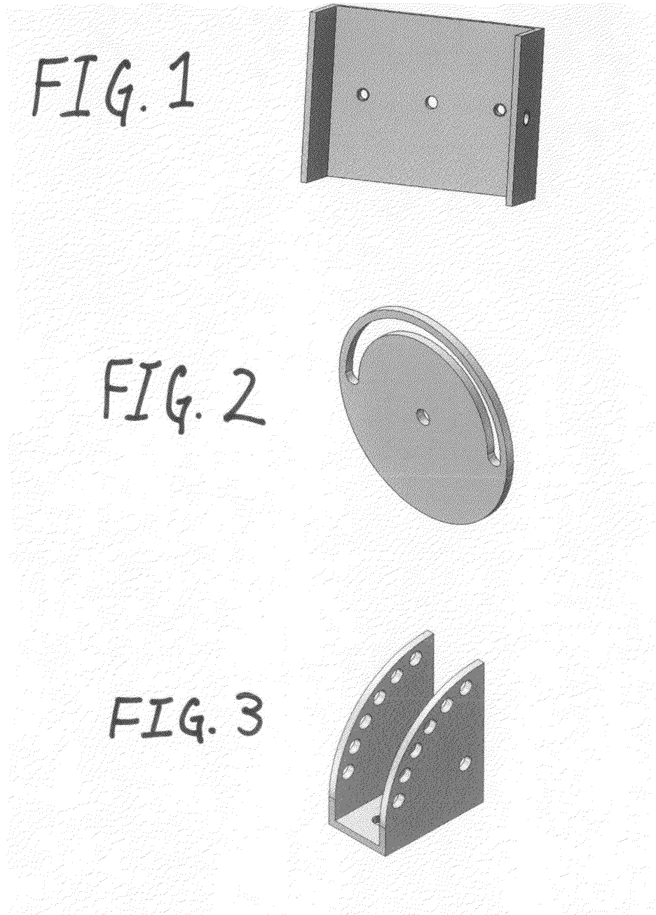

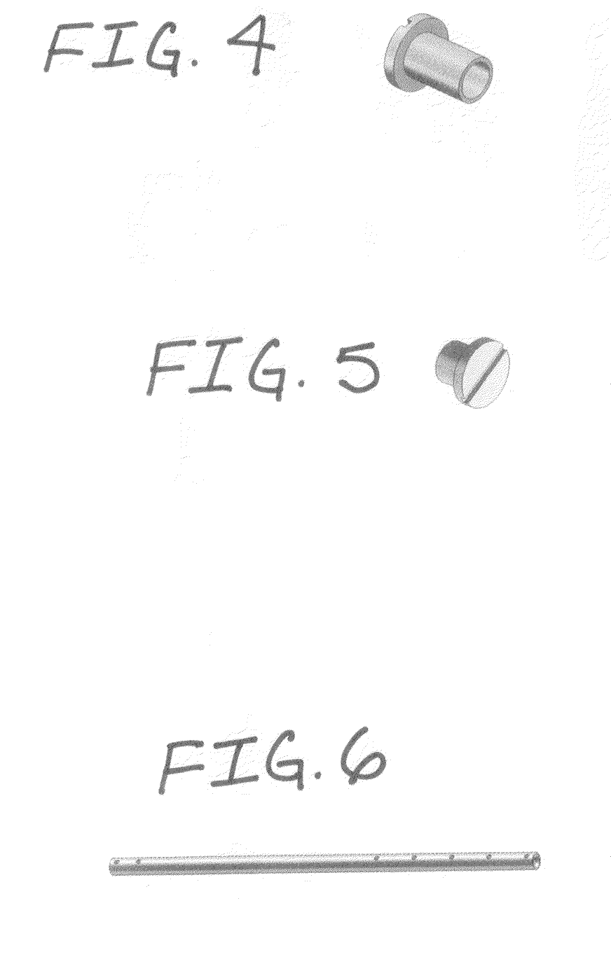

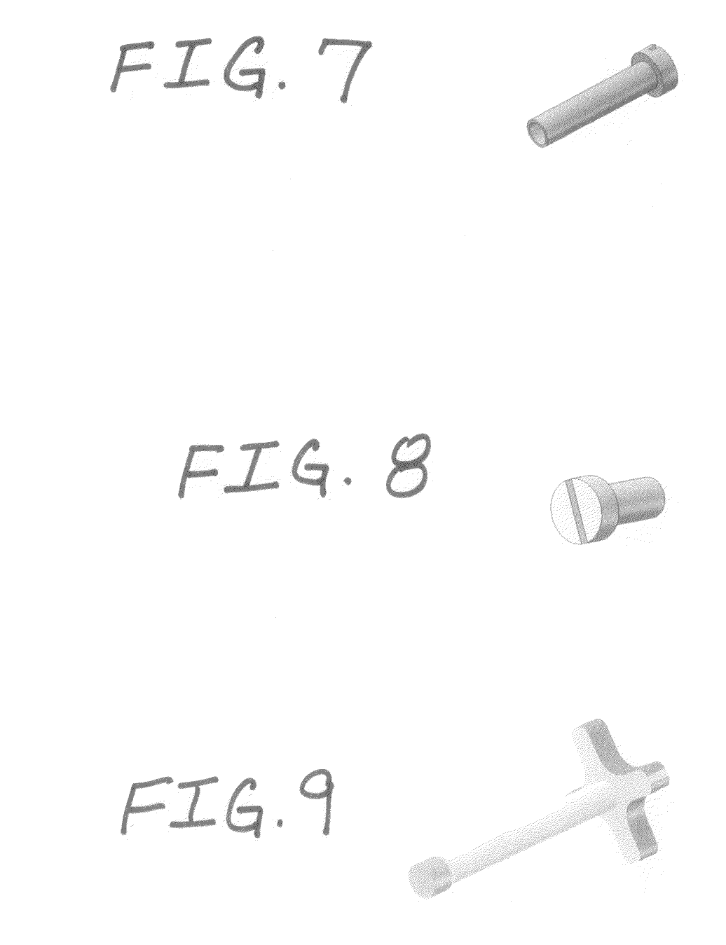

Rotary-Ladder FIG. 2: This component allows the Side-Security-Ladder 26 to turn 360° with the Screw-Pivot-For Channel FIG. 4. The Rotary-Ladder FIG. 2 is welded to the Channel-Adjustment FIG. 3. The welding used is Mig Welding.

Channel-Adjustment FIG. 3: This component will be welded against the Rotary-Ladder FIG. 2 and the process of Mig welding will be used. The Channel-Adjustment FIG. 3 will allow the Side-Security-Ladder 26 the versatility of moving from 90° vertical to 90° horizontal.

Screw-Pivot-For Channel FIG. 4: This component will allow the Rotary-Ladder FIG. 2 to turn 360°. If also join's the Channel-Ladder-Connection FIG. 1, the Rotary-Ladder FIG. 2 and the Channel-Adjustment FIG. 3.

Screw-Lock-For-Channel FIG. 5: This component fastens, with the Screw-Pivot-For Channel FIG. 4, the Channel-Ladder-Connection FIG. 1, the Rotary-Ladder FIG. 2 and the channel adjustment in such a way that allows them to turn 360° and not loosen up.

Ladder-Extension-Base FIG. 6: This component goes inside the Channel-Adjustment FIG. 3. The Ladder-Extension-Base FIG. 6 moves from 90° vertical to 90° horizontal. It uses a Pin-Lock FIG. 21, inside which will insert in one of the six holes that form a half moon on the Channel-Adjustment FIG. 3. A Screw-Pivot FIG. 7 will be used in order to avoid the Ladder-Extension-Base FIG. 6 to fall out of the Channel-Adjustment FIG. 3 and allow the Ladder-Extension-Base FIG. 6 to move from 90° vertical to 90° horizontal. A Screw-Lock FIG. 8 will be used to avoid the Screw-Pivot FIG. 7 from falling out.

Screw-Pivot FIG. 7: This component will go through the upper hole of the Channel-Adjustment FIG. 3 that is not found in the half-moon. At the same time, it goes through the Ladder-Extension-Base FIG. 6. The Screw-Pivot FIG. 7 allows the Ladder-Extension-Base FIG. 6 to move from 90° vertical to 90° horizontal.

Screw-Lock FIG. 8: This component assures that the Ladder-Extension-Base FIG. 6 does not come or fall out of the Channel-Adjustment FIG. 3 and allowing it to move from 90° vertical to 90° horizontal.

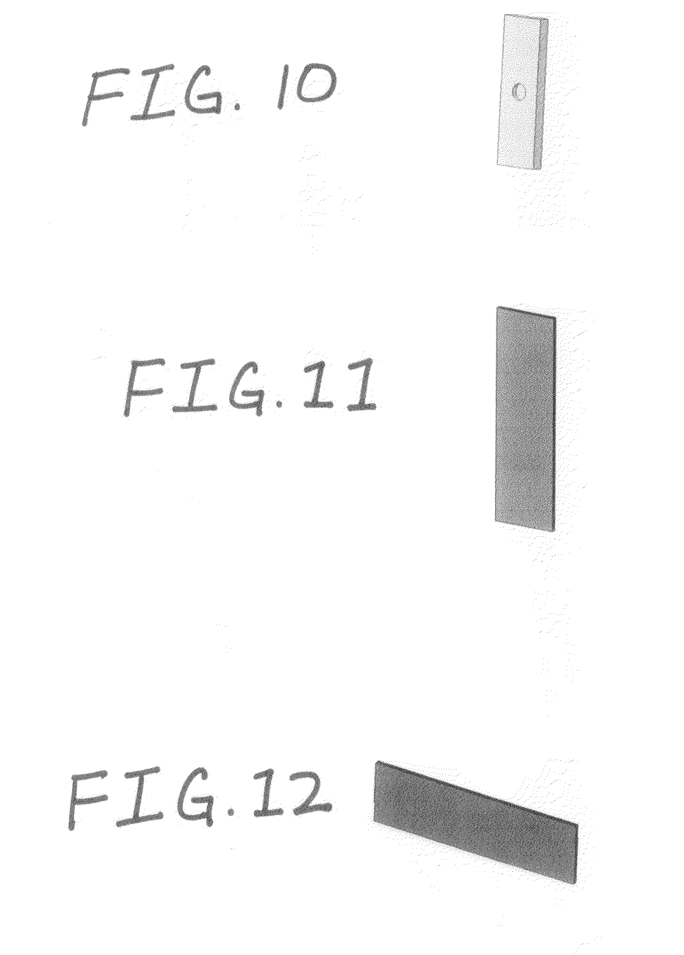

Side-Security-Screw FIG. 9: This component will go through a hole that is found on one of the fringes of the channel-Ladder-Extension FIG. 16. The Side-Security-Screw FIG. 9, the Grab-Bar FIG. 10 and the Rubber-Side-Move FIG. 11 will secure the Side-Security-Ladder 26 to the side (lateral) legs of the Extension Ladder 24.

Grab-Bar FIG. 10: This component will be pressed in the tip of the Side-Security-Screw FIG. 9. The Grab-Bar FIG. 10 will secure the Side-Security-Ladder 26 to the side (lateral) legs of the Extension Ladder 24. The Rubber-Side-Move FIG. 11 will be glued to the Grab-Bar FIG. 10.

Rubber-Side-Move FIG. 11: This Rubber will be used to adhere the Side-Security-Ladder 26 to the side (lateral) legs of the Extension Ladder 24 and isolate the current. This Rubber will be glued to the Grab-Bar FIG. 10.

Rubber-Side FIG. 12: This Rubber will be glued to the fringe that does not have a hole in the Channel-Ladder-Connection FIG. 1. The Rubber-Side FIG. 12 will be used to adhere the Side-Security-Ladder 26 to the side (lateral) legs of the Extension Ladder 24 and isolate the current.

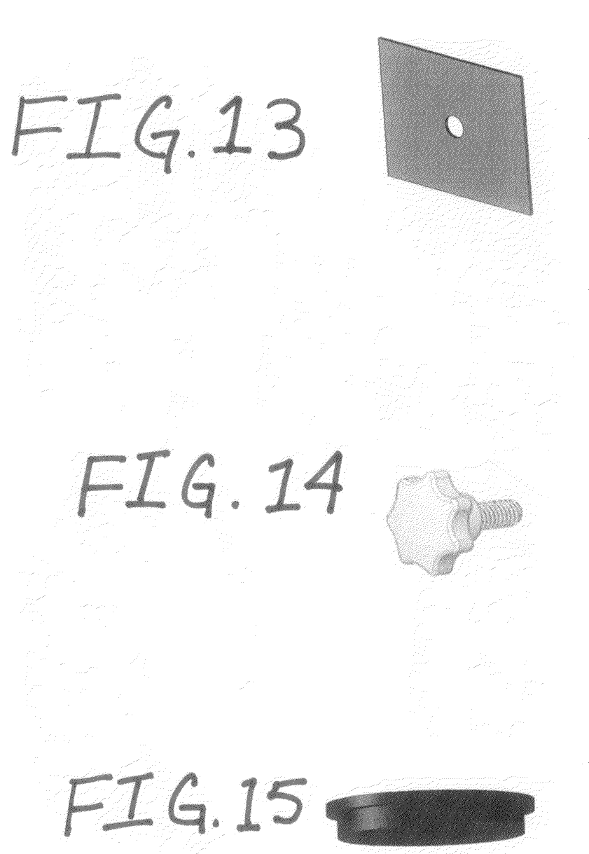

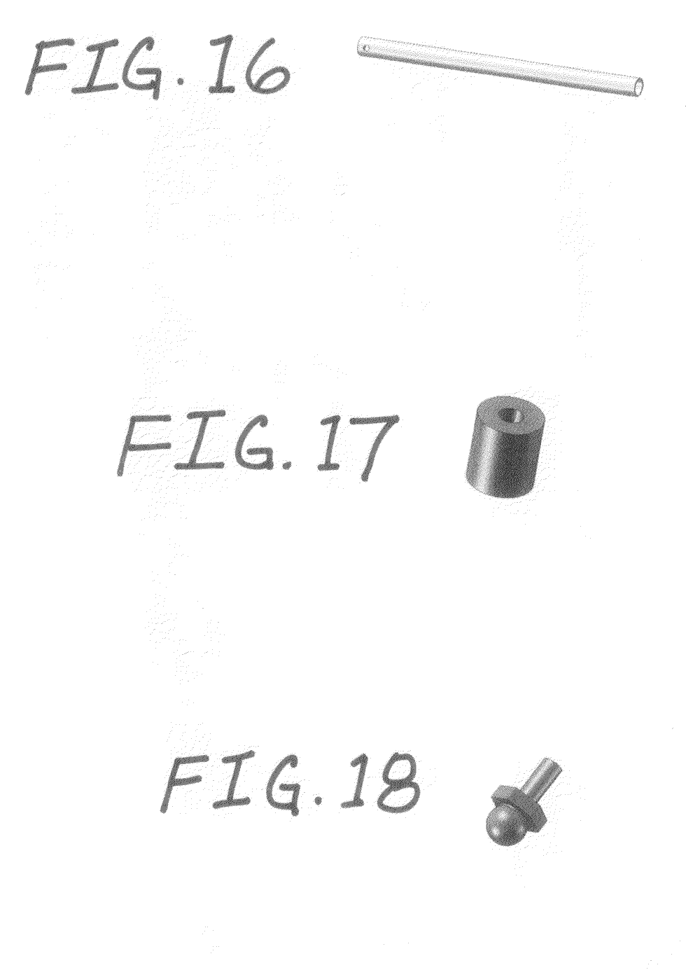

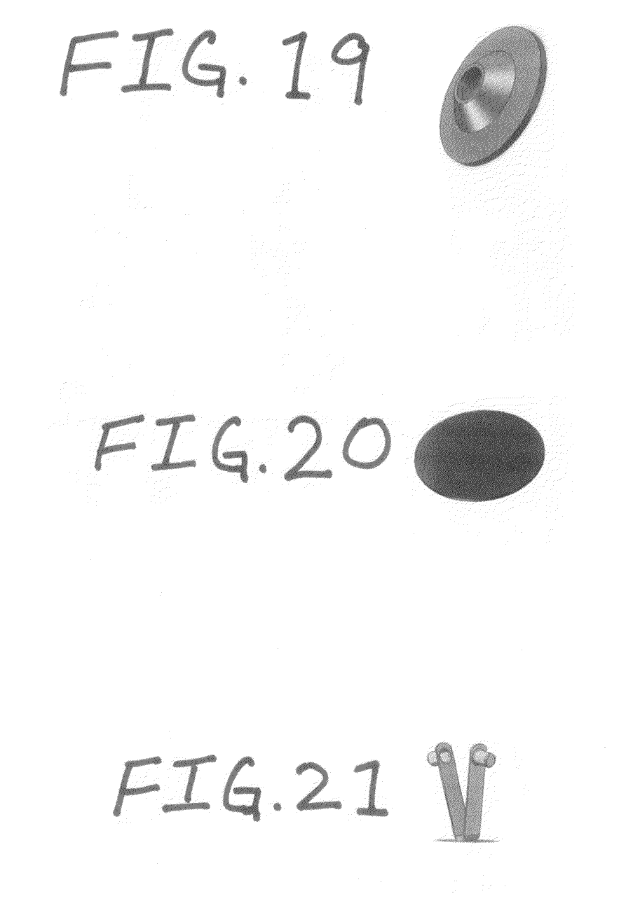

Rubber FIG. 13: This Rubber will allow the Side-Security-Ladder 26 to adhere to the side (lateral) legs of the Extension Ladder 24 and isolate the current. The Rubber FIG. 13 will be glued to the interior (inner) part of the Channel-Ladder-Connection FIG. 1.

Security-Screw FIG. 14: This component will go through inside the slot of the Rotary-Ladder FIG. 2 and screwed in either one of the holes of the Channel-Ladder-Connection FIG. 1 that matches with the slot of the Rotary-Ladder FIG. 2 so that the Side-Security-Ladder 26 will not turn.

Cap-Cover FIG. 15: This component will be pressed into the upper part of the Ladder-Extension-Base FIG. 6. The purpose of the cap is to avoid that any particles may enter and damage the Side-Security-Ladder 26's function.

Ladder-Extension FIG. 16: This component is introduced inside the Ladder-Extension—Base FIG. 6. The Ladder-Extension FIG. 16 will have a Pin-Lock FIG. 21 inside its upper part. This will allow the Pin-Lock FIG. 21 to move up and down inside the Ladder-Extension-Base FIG. 6 using the five holes separated on the bottom part of the Ladder-Extension-Base FIG. 6. This way, the Side-Security-Ladder 26 can extend from 2 to 3 feet. The Ladder-Extension FIG. 16 will have a Bushing-For-Leg FIG. 17 in its interior bottom part.

Bushing-For-Leg FIG. 17: This component will be pressed into the bottom part of the Ladder-Extension FIG. 16. It will be used to screw in the Leg-Joint FIG. 18.

Leg-Joint FIG. 18: This component will be screwed in the Bushing-For-Leg FIG. 17 and will allow the Shoe-Support FIG. 19 to pivot up to 30°.

Shoe-Support FIG. 19: This component, along with the Leg-Joint FIG. 18, will offer the Side-Security-Ladder 26 the versatility of adjusting to any surface and pivot up to 30°. The Shoe-Support FIG. 19 will be assembled to the Leg-Joint FIG. 18.

Leg-Rubber FIG. 20: This Rubber will be glued to the Shoe-Support FIG. 19. It will avoid the Side-Security-Ladder 26 from sliding or skidding. The Leg-Rubber FIG. 20 will also isolate the current and allows the Side-Security-Ladder 26 to adhere to any surface.

Pin-Lock FIG. 21: This component will be placed in two parts. The first Pin-Lock FIG. 21 is placed inside the upper part of the Ladder-Extension-Base FIG. 6. This will allow the Ladder-Extension-Base FIG. 6 to move from 90° vertical to 90° horizontal in a safe way using the six holes that from a half moon of the Channel-Adjustment FIG. 3.

The other Pin-Lock FIG. 21 is found inside the upper part of the ladder extension. Here, in this position, it allows the Side-Security-Ladder 26 to extend from 2 to 3 feet in a safe and secure way. The Pin-Lock FIG. 21 will use the five holes on the Ladder-Extension FIG. 16 base to extend up to 3 feet.

The manufacturing process of the Side-Security-Ladder 26 starts as following: All of the components that are made of aluminum, except the aluminum pipes and screws, will be produced or manufactured in pressure press in the machinery area. Each pressure press will have a die that will form the component. Each die will have one or more stations depending on the complexity of the component. The component comes out already finished at this stage. The dies will be fed with aluminum plates and the thickness will vary according to the components.

The aluminum pipes will be bought according to the interior and exterior diameter that the plan requires. As soon as the aluminum pipes arrive at the production center, they are sent to the machinery area. In this area, the pipes will be cut to measure. Then they will be sent to the drill machines where they will be drilled to measure. In the last stage of machinery work in the manufacturing area, the pipes will be cleaned inside with long brushes that are mounted on drills that are fixed in order to eliminate any shaving of metal. Some fixtures will be used during the process of machinery in order to facilitate and advance the production processes.

The manufacturing process of the aluminum screws and the steel components will be produced in Swiss C.N.C. lathes in the machinery area. These lathes have the versatility of making the whole component with its functions without having to use another machine to produce a particular function. For this, there will be a design or programming area where a person will be in charge of the design of the entire component. When the program is finished, it will be taken to a C.N.C lathe and an operator will prepare the set-up or setting and produce it. Here the component will come out totally complete and finished.

The process of manufacturing the Rubber will be done in the machinery area. The Rubber will be produced on pressure presses which will have a die with only one station. The dies will be fed with rolls of Rubber of 1/16 inch thick. Here the Rubber comes out totally finished.

The process of manufacturing the plastics will be done in the machinery area. They will be produced in injection molding. These moldings will be fed with small plastic balls and will be made by another company. The plastics will come out of the injection molding machine totally finished.

After the manufacturing process in the machinery area, each component will be sent to the assembly area which is divided into five sections. The lateral sides of the Channel-Adjustment FIG. 3 will be welded to the Rotary-Ladder FIG. 2 using Mig welding in the first section. Then these components will go to the second section where the Channel-Ladder-Connection FIG. 1 will be assembled to them using the Screw-Pivot-For Channel FIG. 4 and the Screw-Lock-For-Channel FIG. 5. In the third section, the Rubber-Side FIG. 12 and the Rubber FIG. 13 will be glued to the components that are already assembled. In this section, the Grab-Bar FIG. 10 will be glued to the Rubber-Side-Move FIG. 11. All of these components will move to the fourth section where the Side-Security-Screw FIG. 9, the ladder extension base with the Pin-Lock FIG. 21 inside will be added to the components already assembled. This Ladder-Extension-Base FIG. 6 will be placed inside the Channel-Adjustment FIG. 3 which will be secured with the screw-pivot FIG. 7 and the Screw-Lock FIG. 8. The Cap-Cover FIG. 15 will also be placed.

All of these components already assembled will move on to the fifth station where other components will be added to them. The Ladder-Extension FIG. 16 will be introduced into the Ladder-Extension-Base FIG. 6. The Ladder-Extension FIG. 16 already has the Pin-Lock FIG. 21 introduced in its upper part and the Bushing-For-Leg FIG. 17 in its lower part. Then the Leg-Joint FIG. 18 is screwed to the Bushing-For-Leg FIG. 17, and last of all, the Shoe-Support FIG. 19 will be assembled to the Leg-Joint FIG. 18.

After all of this assembly and in the last stage, these components will be sent back to the third section where the Leg-Rubber FIG. 20 will be glued to the Shoe-Support FIG. 19. Now the finished Side-Security-Ladder 26 will be sent to the packing area where they will be packed in pairs with the usage instruction and the pertinent labels. Last of all, they will be sent to the shipping area for their distribution.

All of the production processes will be done under OSHA regulations and all pertinent agencies.

The Side-Security-Ladder 26 will have the capacity of holding up to 235 pounds in a safe and secure way. More than 235 pounds is not safe or recommended. The Side-Security-Ladder 26 can be used in Extension Ladder 24 made of aluminum and fiber glass. Therefore, there is no other stabilizer the same as this one.

The Side-Security-Ladder 26 is used in the following way: Place the Channel-Ladder-Connection FIG. 1 on any part of the lateral legs of the Extension Ladder 24 and secure them with the Side-Security-Screw FIG. 9. Turn to the degrees needed with the rotary ladder and secure it with the Security-Screw FIG. 14. Extend, if necessary, the Ladder-Extension FIG. 16 by using the Pin-Lock FIG. 21. Move the Ladder-Extension-Base FIG. 6 by using the Pin-Lock FIG. 21 from 90° vertical to 90° horizontal. There is a shoe in the lower part of the Ladder-Extension FIG. 16 that will pivot up to 30°. This way, the Side-Security-Ladder 26 can be used against the floor, walls, roofs and eaves. This will allow to stabilize the Extension Ladder 24 in such a way that they will not move sideways or produce any radical movements. Therefore, one can climb up and down the Extension Ladder 24 in a stabled, confident, and above all, secure way.

On the other hand, we can use aluminum “T-6” for the following figures: FIG. 1, FIG. 2, FIG. 3, FIG. 4, FIG. 5, FIG. 6, FIG. 7, FIG. 8, FIG. 9, FIG. 10, FIG. 14, FIG. 16 and FIG. 21. “Cold Roll Steel” will be used for the following figures: FIG. 17, FIG. 18 and FIG. 19. Rubber will be used for the following figures: FIG. 1, FIG. 12, FIG. 13 and FIG. 20. The following figures will be made of plastic (Polypropylene): FIG. 9, FIG. 14 and FIG. 15. Locttie glue will be used for the figures made of rubber.

1) A ladder stabilizing device for extension ladders utilized in pairs on any part (top, middle or bottom) of the lateral legs of the extension ladder, each of said devices comprising: a guide (Channel-Ladder-Connection) that is placed on each lateral leg of the extension ladder and is secured with a screw (Side-Security-Screw), said screw has a plate on its end (Grab-Bar) so it won't disengage from the lateral legs of the extension ladder; the plane part of said guide (Channel-Ladder-Connection) which doesn't connect with the lateral legs of the extension ladder comprising: a round plate (Rotary-Ladder) that turns 360° and on top of the plate (Rotary-Ladder) there is another guide (Channel-Adjustment) in which there is a pipe (Ladder-Extension-Base) inside the guide (Channel-Adjustment) that moves 90° vertical to 90° horizontal; said pipe (Ladder-Extension-Base) has another pipe (Ladder-Extension) inside that allows the stabilizer to extend towards the floor, walls, roofs, and eaves and the bottom end of the second tube (Ladder-Extension) comprising: a round plate (Shoes) that pivots up to 30° in such a way that the stabilizer (Side-Security-Ladder) adjusts to the person's necessity.

2) The ladder stabilizing device of claim 1, wherein said stabilizing device has a screw (Security-Screw) that will pass through the slot of the round plate and is screwed to the guide and said screw will not allow the stabilizer to move from the degrees already positioned.

3) The ladder stabilizing device of claim 1, wherein said stabilizing device moves from 90° vertical to 90° horizontal and has a safety pin (Pin-Lock) which will not allow the stabilizing device to move as well as the pipe (Ladder-Extension-Base) because both use the same security system (Pin-Lock).
